(19) United States
(12) Patent Application Publication
(10) Pub. No.: US 2026/0164184 A1
(43) Pub. Date: Jun. 11, 2026

(54) VIBRATION DRIVING APPARATUS

(71) Applicant: LG Display Co., Ltd., Seoul (KR)

(72) Inventors: YongWoo LEE, Paju-si (KR); MinKyu CHOI, Paju-si (KR); Sungtae LEE, Paju-si (KR); Seonwook LEE, Paju-si (KR); DoHyeong KIM, Paju-si (KR)

(73) Assignee: LG Display Co., Ltd., Seoul (KR)

(21) Appl. No.: 19/184,174

(22) Filed: Apr. 21, 2025

(30) Foreign Application Priority Data
Dec. 9, 2024 (KR) 10-2024-0182079

(51) Int. Cl. H04R 9/06; H04R 9/04; H04R 17/00

(52) U.S. Cl. CPC H04R 9/06; H04R 9/046; H04R 17/00; H04R 2400/07; H04R 2499/15

(57) ABSTRACT

A vibration driving apparatus may include a vibration member, and a vibration apparatus configured to vibrate the vibration member. The vibration apparatus may include a sound generating module, a vibration module connected to the sound generating module, and a spring member between the sound generating module and the vibration module.

### CROSS-REFERENCE TO RELATED APPLICATIONS

This application claims the benefit of and priority to Korea Patent Application No. 10-2024-0182079 filed on Dec. 9, 2024, the entire contents of which are incorporated herein by reference for all purposes.

### BACKGROUND

### 1. Technical Field

The present disclosure relates to a vibration driving apparatus.

### 2. Description of the Related Art

An apparatus such as a display apparatus must install a separate speaker to provide sound. When a speaker is disposed on a display apparatus, since the speaker occupies a space, a problem occurs in that the design and space arrangement of the display device are restricted.

Since the sound output from the speaker travels backward or downward of the apparatus, there is a problem of poor sound quality due to interference between sounds reflected from the wall or the ground.

The description of the related art should not be assumed to be prior art merely because it is mentioned in or associated with this section. The description of the related art includes information that describes one or more aspects of the subject technology, and the description in this section does not limit the invention.

### SUMMARY

The inventors of the present disclosure have conducted several experiments to realize an apparatus capable of recognizing above-mentioned problems, improving sound quality, and having reliability. Through several experiments, a vibration driving apparatus having a new structure capable of improving sound quality and improving reliability has been invented.

According to the embodiment of this disclosure, a vibration driving apparatus including a vibration apparatus that is configured on the rear surface of the vibration member, can generate sound by vibrating the vibration member, and can improve sound pressure characteristics.

Additional advantages and features of the disclosure will be set forth in part in the description which follows and in part will become apparent to those having ordinary skill in the art upon examination of the following or can be learned from practice of the disclosure. The objectives and other advantages of the disclosure can be realized and attained by the structure particularly pointed out in the written description as well as the appended drawings.

To achieve these and other embodiments of the inventive concepts, as embodied and broadly described herein, a vibration driving apparatus may comprise a vibration member, and a vibration apparatus configured to vibrate the vibration member. The vibration apparatus may comprise a sound generating module, a vibration module connected to the sound generating module, and a spring member between the sound generating module and the vibration module.

According to one or more embodiments of the present disclosure, a vibration driving apparatus may vibrate the vibration member by configuring the vibration apparatus on the rear surface of the vibration member, and sound may be generated to the front surface of the vibration driving apparatus.

According to one or more embodiments of the present disclosure, the vibration driving apparatus includes a sound generating module and a vibration apparatus in which the vibration module is integrated, and thus, acoustic characteristics and/or sound pressure characteristics of the mid-low range and mid-high range may be improved.

According to one or more embodiments of the present disclosure, the vibration driving apparatus may implement stable acoustic and/or sound pressure characteristics by forming a spring member between the sound generating module and the vibration module.

According to one or more embodiments of the present disclosure, the vibration driving apparatus includes a sound generating module and a vibration apparatus in which the vibration module is integrated, and thus, the vibration driving apparatus has an effect of uni-materialization.

According to one or more embodiments of the present disclosure, the vibration driving apparatus may simplify the structure of the vibration driving apparatus and reduce manufacturing costs by including a sound generating module and a vibration apparatus in which the vibration module is integrated.

Other systems, methods, features and embodiments will be, or will become, apparent to one with skill in the art upon examination of the following figures and detailed description. It is intended that all such additional systems, methods, features and embodiments be included within this description, be within the scope of the present disclosure, and be protected by the following claims. Nothing in this section should be taken as a limitation on those claims. Further embodiments and features are discussed below in conjunction with embodiments of the disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure.

FIG. 1 is a diagram illustrating a vibration driving apparatus according to an embodiment of the present disclosure.

FIG. 2 is a diagram illustrating a vibration driving apparatus according to an embodiment of the present disclosure.

FIG. 3 is a cross-sectional view taken along line I-I′ shown in FIG. 2 according to an embodiment of the present disclosure.

FIG. 4 is a cross-sectional view of the vibration apparatus shown in FIG. 3 according to an embodiment of the present disclosure.

FIG. 5 is a diagram illustrating a vibration module according to an embodiment of the present disclosure.

FIG. 6 is a cross-sectional view taken along the line II-II′ shown in FIG. 5 according to an embodiment of the present disclosure.

FIG. 7 is a cross-sectional view of a vibration apparatus according to another embodiment of the present disclosure.

FIG. 8 is a cross-sectional view of a vibration apparatus according to another embodiment of the present disclosure.

FIG. 9 is a cross-sectional view of a vibration apparatus according to another embodiment of the present disclosure.

Throughout the drawings and the detailed description, unless otherwise described, the same drawing reference numerals should be understood to refer to the same elements, features, and structures. The sizes, lengths, and thicknesses of layers, regions and elements, and depiction thereof may be exaggerated for clarity, illustration, and/or convenience.

### DETAILED DESCRIPTION

Reference will now be made in detail to the exemplary embodiments of the present disclosure, examples of which are illustrated in the accompanying drawings. Wherever possible, the same reference numbers will be used throughout the drawings to refer to the same or like parts.

Advantages and features of the present disclosure, and implementation methods thereof will be clarified through following embodiments described with reference to the accompanying drawings. The present disclosure can, however, be embodied in different forms and should not be construed as limited to the embodiments set forth herein. Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details. Like reference numerals refer to like elements throughout. In the following description, when the detailed description of the relevant known function or configuration is determined to unnecessarily obscure the important point of the present disclosure, the detailed description will be omitted. When “comprise,” “have,” and “include” described in the present disclosure are used, another part can be added unless “only” is used. The terms of a singular form can include plural forms unless referred to the contrary. For example, an element may be one or more elements. An element may include a plurality of elements. The word “exemplary” is used to mean serving as an example or illustration. The term “the embodiment” may refer to “an embodiment” and vice versa. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, the embodiment, the example, the example embodiment, the aspect, or the like may refer to one or more embodiments, one or more examples, one or more example embodiments, one or more aspects, or the like, unless stated otherwise.

In construing an element, the element is construed as including an error or tolerance range although there is no explicit description of such an error or tolerance range.

In describing a position relationship, for example, when a position relation between two parts is described as, for example, “on,” “over,” “under,” and “next,” one or more other parts can be disposed between the two parts unless a more limiting term, such as “just” or “direct (ly)” is used.

In describing a time relationship, for example, when the temporal order is described as, for example, “after,” “subsequent,” “next,” and “before,” a case that is not continuous can be included unless a more limiting term, such as “just,” “immediate(ly),” or “direct(ly)” is used.

It will be understood that, although the terms “first,” “second,” etc. can be used herein to describe various elements, these elements should not be limited by these terms. These terms are only used to distinguish one element from another and may not define order of sequence. For example, a first element could be termed a second element, and, similarly, a second element could be termed a first element, without departing from the scope of the present disclosure.

In describing elements of the present disclosure, the terms “first,” “second,” “A,” “B,” “(a),” “(b),” etc. can be used. These terms are intended to identify the corresponding elements from the other elements, and basis, order, or number of the corresponding elements should not be limited by these terms. The expression that an element is “connected,” “coupled,” or “adhered” to another element or layer should be understood the element or layer cannot only be directly connected or adhered to another element or layer, but also be indirectly connected or adhered to another element or layer with one or more intervening elements or layers “disposed,” or “interposed” between the elements or layers, unless otherwise specified.

The term “at least one” should be understood as including any and all combinations of one or more of the associated listed items. For example, the meaning of “at least one of a first item, a second item, and a third item” denotes the combination of all items proposed from two or more of the first item, the second item, and the third item as well as the first item, the second item, or the third item. Also, the term “can” used herein includes all meanings and definitions of the word “may”.

Features of various embodiments of the present disclosure can be partially or overall coupled to or combined with each other, and can be variously inter-operated with each other and driven technically as those skilled in the art can sufficiently understand. The embodiments of the present disclosure can be carried out independently from each other, or can be carried out together in co-dependent relationship.

Hereinafter, embodiments of the present disclosure will be described in detail with reference to the accompanying drawings.

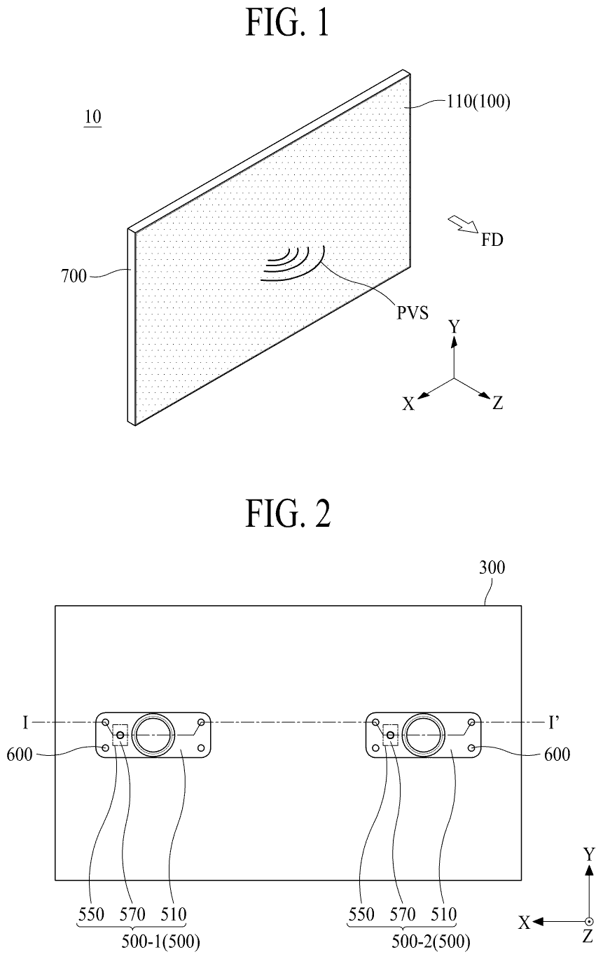

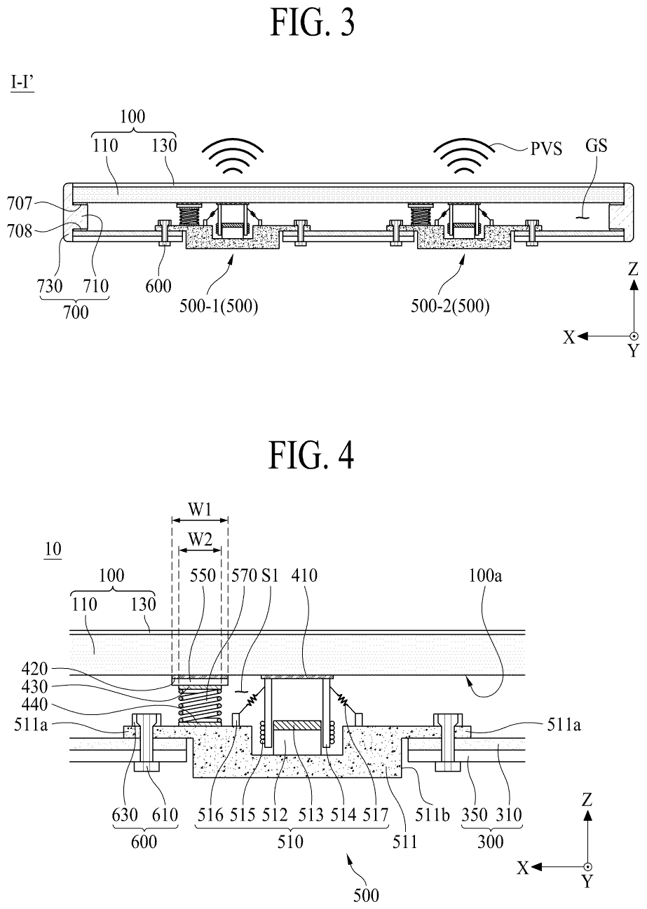

FIG. 1 is a diagram illustrating a vibration driving apparatus according to an embodiment of the present disclosure. FIG. 2 is a diagram illustrating a vibration driving apparatus according to an embodiment of the present disclosure. FIG. 3 is a cross-sectional view taken along line I-I′ shown in FIG. 2 according to an embodiment of the present disclosure. FIG. 4 is a cross-sectional view of the vibration apparatus shown in FIG. 3 according to an embodiment of the present disclosure.

Referring to FIGS. 1 to 4, a vibration driving apparatus 10 according to an embodiment of the present disclosure may include a vibration member 100, a rear cover 300, a vibration apparatus 500, and a middle frame 700.

The vibration member 100 may vibrate according to the driving of at least one vibration apparatus 500 while displaying an image, thereby outputting sound (PVS) (or panel vibration sound) in the forward direction (FD). The vibration member 100 may vibrate according to the driving of at least one vibration apparatus 500 without displaying an image, outputting sound (PVS) in the forward direction (FD). Accordingly, the vibration member 100 according to the present disclosure may simultaneously display an image and generate (or output) sound (PVS).

The vibration member 100 may include a display panel 110 and a functional film 130.

The display panel 110 may display an image. For example, the image may include an electronic image or a digital image. For example, the display panel 110 may output light to display an image. The display panel 110 may be any type of display panel or curved display panel such as a liquid crystal display panel, an organic light emitting display panel, a quantum dot light emitting display panel, a micro light emitting diode display panel, and an electrophoretic display panel. The display panel 110 may be a flexible display panel. For example, the display panel 110 may be a flexible light emitting display panel, a flexible electrophoretic display panel, a flexible electronic wet display panel, a flexible micro light emitting diode display panel, or a flexible quantum dot light emitting display panel, but is not limited thereto.

The display panel 110 vibrates according to a vibration of the vibration apparatus 500 to directly output the sound PVS to the front FD, and thus, the display panel 110 may be a diaphragm or a speaker that directly generates the sound PVS. For example, when the vibration member 100 generates the sound PVS, the vibration member 100 may be a diaphragm, a panel speaker, or a flat speaker that directly generates the sound PVS.

According to an embodiment of the present disclosure, the display panel 110 may include a pixel circuit disposed on a substrate (or a base substrate), and a pixel array layer (or a display area) connected to the pixel circuit and having an anode electrode, a cathode electrode, and a light emitting layer. The anode electrode may be a first electrode, a pixel electrode, or the like, but is not limited thereto. The cathode electrode may be a second electrode, a common electrode, or the like, but is not limited thereto. The display panel 110 may display an image in the form of a top emission type, a bottom emission type, or a dual emission type according to a structure of the pixel array layer. The top emission type may display an image by emitting visible light generated from the pixel array layer to the front of the substrate of the display panel 110. The bottom emission type may display an image by emitting visible light generated from the pixel array layer to the outside through the substrate.

According to an embodiment of the present disclosure, the display panel 110 may include a pixel array unit disposed in a pixel area formed by a plurality of gate lines and/or a plurality of data lines. The pixel array unit may include a plurality of pixels that display an image according to a signal supplied to the signal lines. The signal lines may include a gate line, a data line, a pixel driving power line, and the like.

Each of the plurality of pixels may include a pixel circuit layer including a driving thin film transistor provided in the pixel area, an anode electrode electrically connected to the driving thin film transistor, a light emitting layer formed on the anode electrode, and a cathode electrode electrically connected to the light emitting layer.

The driving thin film transistor may be configured in a transistor region of each pixel region disposed on the substrate. The driving thin film transistor may include a gate electrode, a gate insulating layer, an active layer, a source electrode, and a drain electrode. The active layer of the thin film transistor may include silicon such as a-Si, poly-Si, or low temperature poly-Si, or may include an oxide such as indium-galium-Zinc-Oxide (IGZO), but is not limited thereto.

The anode electrode may be provided in an opening area disposed in each pixel area to be electrically connected to the driving thin film transistor.

The light emitting layer according to the embodiment of the present disclosure may include an organic light emitting device formed on an anode electrode. The organic light emitting device may be implemented to emit light of the same color for each pixel, for example, white, or may be implemented to emit light of one or more of different colors, for example, red, green, and blue for each pixel.

The light emitting layer according to another embodiment may include a micro light emitting diode device electrically connected to each of an anode electrode and a cathode electrode. The micro light emitting diode device is a light emitting diode implemented in the form of an integrated circuit (IC) or a chip, and may include a first terminal electrically connected to the anode electrode and a second terminal electrically connected to the cathode electrode. The cathode electrode may be commonly connected to the light emitting element of the light emitting layer provided in each pixel area.

Since the encapsulation portion is formed on the substrate to surround the pixel array part, oxygen or moisture may be prevented from penetrating into the light emitting layer of the pixel array area. The encapsulation portion according to an embodiment may be formed in a multilayer structure in which organic material layers and inorganic material layers are alternately stacked, but is not limited thereto. The inorganic material layer may block oxygen or moisture from penetrating into the light emitting device layer of the pixel array area. The organic material layer may be formed to have a relatively thicker thickness than the inorganic material layer so as to cover particles (or foreign substances) that may occur during the manufacturing process. The encapsulation portion may include a first inorganic layer, an organic layer on the first inorganic layer, and a second inorganic layer on the organic layer. The organic layer may be a particle cover layer. The touch panel may be disposed on the encapsulation portion or on the rear surface of the pixel array area.

According to an embodiment of the present disclosure, the display panel 110 may include an upper substrate, a lower substrate, and a liquid crystal layer. The upper substrate is a first substrate or a thin film transistor array substrate, and may include a pixel array (or a display portion or a display area) having a plurality of pixels formed in a pixel area intersected by a plurality of gate lines and/or a plurality of data lines. Each of the plurality of pixels may include a thin film transistor connected to a gate line and/or a data line, a pixel electrode connected to the thin film transistor, and a common electrode formed to be adjacent to the pixel electrode to supply a common voltage.

The upper substrate may further include a pad portion provided at the first edge (or first non-display area) and a gate driving circuit provided at the second edge (or second non-display area).

The pad portion may supply a signal supplied from the outside to the pixel array and/or the gate driving circuit. For example, the pad portion may include a plurality of data pads connected to the plurality of data lines through a plurality of data link lines and/or a plurality of gate input pads connected to the gate driving circuit through a gate control signal line. For example, the size of the upper substrate may be larger than that of the lower substrate, but is not limited thereto.

The gate driving circuit may be embedded (or integrated) in the second edge of the upper substrate to be connected to a plurality of gate lines. For example, the gate driving circuit may be implemented as a shift register including a transistor formed by the same process as the thin film transistor provided in the pixel area. The gate driving circuit according to another embodiment may be implemented in the form of an integrated circuit without being embedded in the upper substrate and included in the panel driving circuit.

The lower substrate may be a second substrate or a color filter array substrate. The lower substrate may include a pixel pattern including an opening area overlapping a pixel area formed in the upper substrate, and a color filter layer formed in the opening area. The lower substrate may have a size smaller than that of the upper substrate, but is not limited thereto. For example, the lower substrate may overlap the remaining portions except for the first edge of the upper substrate. The lower substrate may be bonded to the remaining portions except for the first edge of the upper substrate by a sealant with a liquid crystal layer interposed therebetween.

The liquid crystal layer may be interposed between the upper substrate and the lower substrate. The liquid crystal layer may be formed of a liquid crystal in which the arrangement direction of the liquid crystal molecules is changed according to a data voltage applied to the pixel electrode for each pixel and an electric field formed by the common voltage.

According to an embodiment of present disclosure, the display panel 110 may display an image according to light passing through the liquid crystal layer by driving the liquid crystal layer according to the data voltage applied for each pixel and the electric field formed for each pixel by the common voltage.

In the display panel 110, an upper substrate may be a color filter array substrate, and a lower substrate may be a thin film transistor array substrate. For example, the display panel 110 according to another embodiment of the present disclosure may have a shape in which the display panel 110 according to an embodiment of the present disclosure is inverted vertically. In this case, the pad portion of the display panel 110 according to another embodiment of the present disclosure may be covered by a separate structure.

The display panel 110 may include a bending portion that is bent or curved to have a curved shape or a constant radius of curvature.

The bending portion of the display panel 110 may be implemented on at least one of one edge portion and the other edge parallel to each other in the display panel 110. One edge and/or the other edge of the display panel 110 implementing the bending portion may include only the non-display area, or may include an edge of the display area and the non-display area. For example, the display panel 110 including a bending portion implemented by bending of the non-display area may have a one-sided bezel bending structure or a two-sided bezel bending structure. In addition, the display panel 110 including a bending portion implemented by bending of the edge of the display area and the non-display area may have a one-sided active bending structure or a two-sided active bending structure.

The functional film 130 may be disposed or configured on the display panel 110. The functional film 130 may be disposed or configured on a second surface different from the first surface of the display panel 110. The functional film 130 may be attached onto the display panel 110 via a transparent adhesive member. For example, the adhesive member may include a pressure sensitive adhesive PSA, an optical clear adhesive OCA, or an optical clear resin OCR, but is not limited thereto.

According to an embodiment of the present disclosure, the functional film 130 may include an anti-reflection layer (or an anti-reflection film) for improving outdoor visibility and contrast ratio of an image displayed on the display panel 110 by preventing reflection of external light. For example, the anti-reflection layer may include a circular polarization layer (or a circular polarization film) that blocks the reflected light reflected by the thin film transistor and/or lines disposed on the pixel array layer of the display panel 110 from traveling to the outside.

The functional film 130 may further include an optical path control layer (or an optical path control film) that controls a path of light emitted from the pixel array layer of the display panel 110 to the outside. The optical path control layer may include a structure in which high and low refractive layers are alternately stacked. Accordingly, it is possible to minimize a color shift phenomenon according to a viewing angle by changing the path of light incident from the pixel array layer. For example, the low refractive layer may be disposed on the uppermost layer of the optical path control layer, but is not limited thereto.

According to an embodiment of the present disclosure, the vibration member 100 may further include a touch electrode portion for a user interface using a user touch. The touch electrode portion may be interposed between the display panel 110 and the functional film 130 or may be embedded in the display panel 110 according to an in-cell touch method. For example, the touch electrode portion according to the in-cell touch type may include touch electrodes of a mutual capacitance type or touch electrodes of a self-capacitance type.

According to an embodiment of the present disclosure, the vibration driving apparatus 10 may further include a cover member 300. The cover member 300 may be disposed on a rear surface of the vibration member 100. The cover member 300 may support the vibration member 100. For example, the cover member 300 may be connected to the vibration apparatus 500 to support or fix the vibration apparatus 500.

The cover member 300 may be represented by a cover bottom, a plate bottom, a back cover, a set cover, a back cover, a rear frame, a base frame, a metal frame, a metal chassis, a chassis base, a chassis base, a chassis, an m-chassis, etc. Accordingly, the cover member 300 may be implemented as any type of frame or plate-shaped structure disposed on the rear surface of the vibration member 100. The rear surface of the vibration member 100 may be represented by one surface, a first surface, a rear surface, a lower surface, etc., but is not limited thereto.

According to an embodiment of the present disclosure, the cover member 300 may include a first cover member 310 and a second cover member 350.

The first cover member 310 may be disposed on the rear surface of the vibration member 100. The first cover member 310 may be spaced apart from the rear surface of the vibration member 100 with the gap space GS interposed therebetween. The first cover member 310 may protect the rear surface of the vibration member 100 from an external impact. The first cover member 310 may reinforce the rigidity of the cover member 300 and perform a heat dissipation function. For example, the first cover member 310 may be an inner plate, a rigid plate, or a heat dissipation plate (or heat sink). For example, the first cover member 310 may be formed of a glass material, a metal material, or a plastic material. For example, the glass material may have one or more of sapphire glass and gorilla glass, or a stacked structure (or a bonded structure) thereof. For example, the metal material may have one or more of aluminum, an aluminum alloy, an alloy of iron and nickel, and stainless steel, or a bonded structure thereof.

The second cover member 350 may be disposed on the rear surface of the first cover member 310. For example, the second cover member 350 may cover the rear surface of the first cover member 310. The second cover member 350 may be a plate-shaped member that covers the entire rear surface of the first cover member 310. For example, the second cover member 350 may be formed of at least one of a glass material, a metal material, and a plastic material. For example, the second cover member 350 may be formed of a material different from that of the first cover member 310, but is not limited thereto. For example, the second cover member 350 may have the same thickness as that of the first cover member 310 or may be relatively thinner than that of the first cover member 310. For example, in order to more stably support the vibration apparatus 500 and reduce the weight of the vibration driving apparatus 10, the first cover member 310 may have a relatively thicker thickness than that of the second cover member 350.

According to an embodiment of the present disclosure, the vibration driving apparatus 10 may include at least one vibration apparatus 500. The at least one vibration apparatus 500 may be configured to vibrate the vibration member 100. The vibration apparatus 500 may be connected to the rear surface or the first surface 100a of the vibration member 100. Accordingly, sound or vibration may be generated on the front surface of the vibration member 100.

The vibration apparatus 500 may include a first vibration apparatus 500-1 and a second a vibration apparatus 500-2 disposed in parallel on the first surface of the vibration member 100. The vibration driving apparatus 10 may include a first vibration apparatus 500-1 disposed in the first area (or left area) of the vibration member 100 and a second a vibration apparatus 500-2 disposed in the second area (or right area) of the vibration member 100 with respect to the center of the rear surface of the vibration member 100.

For example, the first vibration apparatus 500-1 may vibrate a first rear area of the vibration member 100 to generate sound PVS due to vibration in a first area (or left area) of the vibration member 100. The second vibration apparatus 500-2 may vibrate a second rear area of the vibration member 100 to generate sound PVS due to vibration in a second area (or right area) of the vibration member 100. For example, the vibration driving apparatus 10 may output sound in a two-channel form by left and right sound separation through the first vibration apparatus 500-1 and the second vibration apparatus 500-2 and 500-2. The first vibration apparatus 500-1 may be configured to output a left sound, and the second vibration apparatus 500-2 may be configured to output a right sound.

According to an embodiment of the present disclosure, the first vibration apparatus 500-1 and the second vibration apparatus 500-2 may be the same vibration apparatus. The first vibration apparatus 500-1 and the second vibration apparatus 500-2 may have the same structure. Each of the first vibration apparatus 500-1 and the second vibration apparatus 500-2 may be a vibration apparatus including the sound generating module 510, the vibration module 550, and the spring member 570. Each of the first vibration apparatus 500-1 and the second vibration apparatus 500-2 may be a vibration apparatus in which the sound generating module 510, the vibration module 550, and the spring member 570 are integrated. In the embodiment of the present disclosure, the present invention has been described by using two vibration apparatus as an example, but the number of vibration apparatus 500 may be variously provided and may be variously arranged according to the size of the vibration member 100.

According to an embodiment of the present disclosure, the vibration apparatus 500 may include a sound generating module 510, at least one vibration module 550, and a spring member 570.

The sound generating module 510 may be disposed or configured on the rear surface or the first surface 100a of the vibration member 100. The sound generating module 510 may be connected to the rear surface or the first surface 100a of the vibration member 100. The sound generating module 510 may vibrate the vibration member 100 to generate a sound to the front surface of the vibration member 100. For example, the sound generating module 510 may be configured to vibrate the vibration member 100 according to a current (or voice current) applied based on Fleming's left-hand rule. The sound generating module 510 may be represented by a sound generation unit, an actuator, a exciter, a transducer, or the like, but is not limited thereto.

According to an embodiment of the present disclosure, the sound generating module 510 may be a coil type sound generating module including a voice coil. Accordingly, the sound generating module 510 may include a base plate 511, a magnet 512, a center pole 513, a bobbin 514, a coil 515, an edge frame 516, and a damper 517.

The base plate 511 may be connected to or fixed to the cover member 300. The base plate 511 may be supported or connected to the cover member 300 via the connection member 600. For example, the base plate 511 may include an extension portion 511a. The extension portion 511a may protrude in parallel from an outer side surface 511b of the base plate 511. The extension portion 511a may be formed between the vibration member 100 and a partial area of the cover member 300 adjacent to the outer side surface 511b of the base plate 511. The extension portion 511a may overlap a partial area of the cover member 300 adjacent to the base plate 511.

The connection member 600 may be coupled to a partial area of the cover member 300 overlapping the extension part 511a and the extension part 511a. Accordingly, the base plate 511 and the cover member 300 may be connected or fixed via the connection member 600. Accordingly, the base plate 511 and the cover member 300 may be integrated via the connection member 600. Accordingly, the sound generating module 510 and the cover member 300 may be integrated via the connection member 600.

The base plate 511 may be a main body of the sound generating module 510. The base plate 511 may support at least one of the magnet 512, the center pole 513, and the edge frame 516. The base plate 511 may include a groove portion for accommodating the magnet 512 and the bobbin 514. For example, the groove portion may be formed to be concave from the upper surface of the base plate 511 to have a circular shape. For example, the base plate 511 may include a plastic material. For example, the base plate 511s may include any one of polycarbonate PC, polyethylene PE, polypropylene PP, polystyrene PS, acrylic PMMA, nylon, and polyamide PA. The base plate 511 may be represented by a lower plate, a base frame, a yoke, but is not limited thereto.

The magnet 512, the center pole 513, the bobbin 514, and the coil 515 may be represented as a magnetic circuit unit or a magnetic vibration unit installed in the base plate 511 to vibrate the vibrating member 100. For example, the magnetic circuit unit may have an external magnetic type or dynamic type structure in which the magnet 512 is disposed outside the coil 515. As another example, the magnetic circuit unit may have an internal magnetic type or micro type structure in which the magnet 512 is disposed inside the coil 515. The sound generating module 510 including the magnetic circuit unit having an internal magnetic type structure may have a small leakage magnetic flux and a small size as a whole. The sound generating module 510 according to an embodiment of the present disclosure may have an external magnetic type or an internal magnetic type structure. In the following description, a case in which the sound generating module 510 has an internal type structure is described as an example.

The magnet 512 may be disposed on the base plate 511. The magnet 512 may use a sintered magnet such as barium ferrite or the like. The magnet 512 may include one or more of iron trioxide Fe₂O₃, barium witherite BaCO₃, neodymium Nd, strontium ferrite Fe₁₂O₁₉Sr with improved magnetic properties, aluminum Al, nickel Ni, cobalt Co alloy cast magnets, etc. For example, a neodymium magnet may be neodymium-iron-boron Nd—Fe—B or the like, but is not limited thereto.

The center pole 513 may be disposed on the magnet 512. The center pole 513 may be received or inserted into the bobbin 514 to guide the lifting of the bobbin 514. For example, the center pole 513 may be received or inserted into the bobbin 514, and thus, an outer surface of the center pole 513 may be surrounded by the bobbin 514. The center pole 513 may be represented by an elevation guider, pole pieces, or the like, but is not limited thereto.

The bobbin 514 may be disposed on the base plate 511. The bobbin 514 may surround the magnet 512. The bobbin 514 may have a circular shape or an elliptical (or oval) shape, but is not limited thereto. For example, in an elliptical bobbin 514, the ratio of the major axis diameter to the minor axis diameter can range from 1.3:1 to 2:1. The elliptical bobbin 514 may improve sound in a higher range than a circular shape. The elliptical bobbin 514 may generate less heat due to vibration, allowing it to have excellent heat dissipation properties. For example, the bobbin 514 may be a structure made of pulp, a paper-processed material, aluminum, magnesium, an alloy thereof, a synthetic resin such as polyimide, or the like. For example, the bobbin 514 may be implemented as a polyimide film having relatively excellent heat dissipation characteristics and relatively light in order to prevent a local image quality defect of the display panel 110 due to heat generated from the coil 515. For example, the polyimide film is excellent in thermal and mechanical strength, and thus reliability of the bobbin 514 may be improved. For example, since polyimide films have excellent heat dissipation properties, there is an effect of reducing the generation of heat due to the vibration of bobbin 514. For example, the polyimide film may be KAPTON, and it may be a condensation product of pyromelitec dianhydride and 4,4′-oxydianiline.

The coil 515 may be wound to surround an outer circumference surface of the bobbin 514 and may receive a current (or voice current) for generating sound from the outside. For example, the coil 515 may be lifted together with the bobbin 514. The coil 515 may be a voice coil. For example, when a current is applied to the coil 515, the entire bobbin 514 moves up and down according to Fleming's left-hand rule based on an applied magnetic field formed around the coil 515 and an external magnetic field formed around the magnet 512. Since the vibration of the display member 100 caused by the up-and-down movement (or vibration) of the bobbin 514, sound PVS or sound waves may be generated from the front surface FD of the vibrating member 100.

The coil 515 may be made of a material having relatively excellent heat dissipation characteristics. For example, the coil 515 may include an aluminum material that has better thermal conductivity than copper, which is a material of a general coil, and thus has relatively excellent heat dissipation characteristics and is relatively lighter than copper. Accordingly, the sound generating module 510 according to an embodiment of the present disclosure may prevent the occurrence of image quality defects in the display panel 110 by transferring heat generated from the coil 515 to the bobbin 514.

The damper 517 may be provided between the base plate 511 and the bobbin 514. One side of the damper 517 may be connected to the base plate 511, and the other end of the damper 517 may be connected to an outer surface of the bobbin 514. The damper 517 may have a corrugated structure between one side and the other side, and may adjust vibration of the bobbin 514 while contracting and relaxing according to vertical movement of the bobbin 514. The damper 517 is connected between the base frame 511 and the bobbin 514 and may limit a vibration distance of the bobbin 514 through a restoring force. For example, when the bobbin 514 vibrates beyond a certain distance or below a certain distance, the bobbin 514 may return to its original position due to the restoring force of the damper 517. For example, the damper 517 may include a metal material electrically connected to the coil 515. For example, the damper 517 may be made of stainless steel, copper (Cu), or the like, but is not limited thereto. The damper 517 may be expressed in other terms such as a spider, a suspension, an edge, or the like, but is not limited thereto.

The edge frame 516 may be installed on the front surface of the base plate 511 and may support the damper 517. The edge frame 516 may be formed at a constant height on the edge of the front surface of the base plate 511.

A first adhesive member 410 may be provided between the vibration member 100 and the sound generating module 510. For example, the vibration member 100 and the sound generating module 510 may be connected to each other via a first adhesive member 410. The first adhesive member 410 may be one or more of a double-sided tape, a double-sided foam tape, a double-sided pad, a double-sided foam pad, a single-side tape, a single-sided foam tape, a single-sided pad, a single-sided foam pad, an adhesive, and a bond, but is not limited thereto.

The vibration driving apparatus 10 according to an embodiment of the present disclosure may include at least one vibration module 550. The vibration driving apparatus 10 according to an embodiment of the present disclosure may include a single vibration module 550.

The vibration module 550 may be provided between the vibration member 100 and the sound generating module 510. The vibration module 550 may be connected to a rear surface or a first surface 100a of the vibration member 100. The vibration module 550 may be provided between the vibration member 100 and the base plate 511. The vibration module 550 may be connected to the sound generating module 510 via a spring member 570. The vibration module 550 may be integrated with the sound generating module 510 via a spring member 570.

According to an embodiment of the present disclosure, the vibration module 550 may have a structure different from that of the sound generating module 510. For example, the vibration module 550 may include a film-type vibration module. For example, the vibration module 550 may include a piezoelectric material having a piezoelectric effect, a composite piezoelectric material, or an electroactive material.

The sound pressure characteristics may be affected according to the attachment positions of the sound generating module 510 and the vibration module 550. For example, when the sound generating module 510 and the vibration module 550 are individually attached to the vibration member 100, a distance between the sound generating module 510 and the vibration module 550 may be far. Accordingly, the sound pressure characteristics of the mid and low ranges are maintained in the area where the sound generation module 510 is attached, and the sound pressure characteristics of the mid and high range may be maintained in the area where the vibration module 550 is attached. Therefore, the sound pressure characteristics in the vibration member 100 or display panel 110 may be non-uniform according to the area. According to an embodiment of the present disclosure, since the sound generating module 510 and the vibration module 550 are integrated, sound pressure characteristics that are uniform on the front surface of the vibration member 100 or the display panel 110 may be maintained without being affected by the attachment position.

According to an embodiment of the present disclosure, the vibration module 550 may be disposed on one side or the other side of the base plate 511 to be spaced apart from the magnet 512, the bobbin 514, and the coil 515 generating sound or vibration. For example, the vibration apparatus 500 is connected to the cover member 300 via the connection member 600, and thus, a first space S1 may be generated on one side or the other side between the vibration member 100 and the base plate 511. The vibration module 550 may be disposed in the first space S1 between the vibration member 100 and the base plate 511 to be spaced apart from the magnet 512, the bobbin 514, and the coil 515.

When the vibration module 550 contacts the magnet 512, the bobbin 514, and the coil 515 generating sound or vibration, durability of the vibration module 550 including the piezoelectric material may be relatively weak. Accordingly, fatigue damage of the vibration module 550 may occur due to vibration. In the vibration driving apparatus 10 according to an embodiment of the present disclosure the magnet 512, the bobbin 514, and the coil 515 generating sound or vibration are separated from each other, and thus fatigue damage may not occur. The vibration driving apparatus 10 according to the embodiment of the present disclosure can enhance the sound pressure characteristics of the mid-low range and the mid-high range without mutual interference, without the vibration module 550 and the magnet 512, bobbin 514, and coil 515 that generate sound or vibration coming into contact with each other.

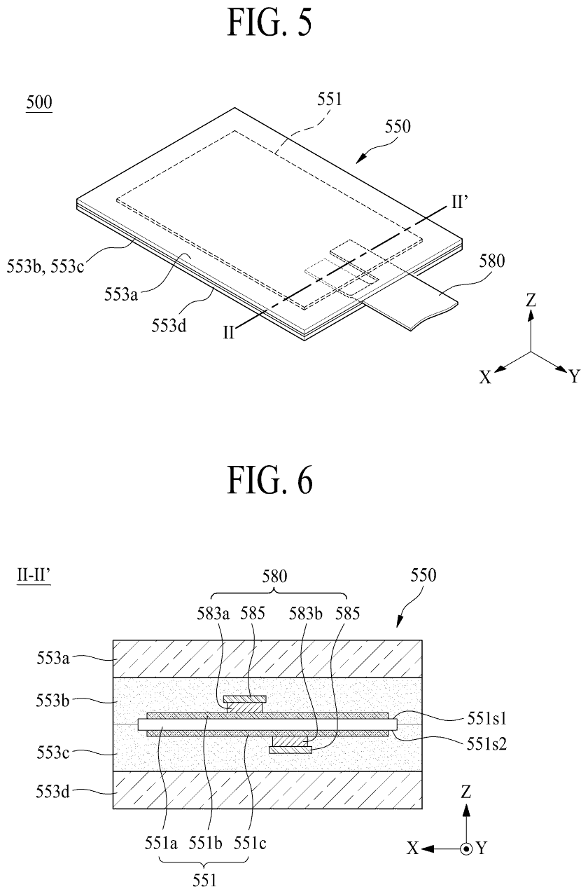

The vibration module 550 may be connected to the signal supply member. The signal supply member may be electrically connected to the pad portion disposed on the vibration module 550 and may supply a vibration driving signal (or an acoustic signal) provided from the vibration driving portion to the vibration module 550. Hereinafter, detailed configurations of the vibration module 550 and the signal supply member will be described in detail with reference to FIGS. 5 and 6.

According to an embodiment of the present disclosure, the vibration apparatus 500 may include a spring member 570. The spring member 570 may be provided on the first surface 100a of the vibration member 100. The spring member 570 may be provided between the vibration module 550 and one side or the other side of the sound generating module 510. The spring member 570 may be connected to the sound generating module 510 and the vibration module 550. The spring member 570 may be connected to the sound generating module 510 and the vibration module 550 while filling a space between the sound generating module 510 and the vibration module 550.

According to an embodiment of the present disclosure, the spring member 570 may be provided between the vibration module 550 and the base plate 511. The spring member 570 supports the vibration module 550, and may guide the vibration module 550 such that the vibration module 550 is easily attached to the vibration member 100. The spring member 570 may support the vibration module 550 such that the vibration module 550 is easily attached to the base plate 511 of the sound generating module 510. The vibration module 550 may be coupled or integrated with the sound generating module 510 by a spring member 570.

A third adhesive member 430 for adhering the spring member 570 and the vibration module 550 may be configured between the spring member 570 and the vibration module 550. A fourth adhesive member 440 for adhering the spring member 570 and the sound generating module 510 may be configured between the spring member 570 and the sound generating module 510. Each of the third adhesive member 430 and the fourth adhesive member 440 may have a width equal to or greater than that of the spring member 570. Accordingly, the vibration module 550 and the spring member 570 may be easily connected via the third adhesive member 430. Accordingly, the sound generating module 510 and the spring member 570 may be easily connected via the fourth adhesive member 440. The third adhesive member 430 and the fourth adhesive member 440 may each include the same material as that of the first adhesive member 410, but are not limited thereto.

According to an embodiment of the present disclosure, the spring member 570 may have a size equal to or smaller than that of the vibration module 550. For example, the width W2 of the spring member 570 may be equal to or smaller than the width W1 of the vibration module 550, but is not limited thereto. For example, the spring member 570 may be disposed in a central portion of the vibration module 550. Accordingly, the vibration module 550 may be safely supported while receiving a uniform force horizontally or vertically, and may be easily coupled to the vibration member 100.

According to an embodiment of the present disclosure, the spring member 570 may include a metallic material. The spring member 570 may have elasticity and restoring force. For example, the spring member 570 may be at least one structure configured to accumulate buffering action and mechanical energy using the elasticity and restoring force of a material. For example, the spring constant of the spring member 570 may be 50 N/m or less. For example, the spring constant may be determined according to the line thickness, the effective number of windings, length, outer diameter, inner diameter, material, and the like. For example, the line thickness may be the thickness of the spring member 570. For example, the effective number of windings may be the number of times the spring is wound around the spring member 570. The line thickness of the spring member 570 may be 0.4 mm, the effective number of windings is 5 times, the length may be 8 mm, the outer diameter may be 12 mm, and the inner diameter may be 11.2 mm. The spring member 570 may be made of a SUS-based material. For example, the spring member 570 may include any one of SUS 316, SUS 304, SUS 302, and SUS 631.

Accordingly, in the process of connecting the vibration apparatus 500 to the vibration member 100, the spring member 570 may be compressed and the vibration module 550 may be pressed in the direction of the vibration member 100.

The vibration driving apparatus 10 according to the embodiment of the present disclosure includes a spring member 570, and thus the vibration module 550 may be easily coupled to the first surface 100a of the vibration member 100 and the sound generating module 510. In the vibration driving apparatus 10 according to the embodiment of the present disclosure, the vibration module 550 and the sound generating module 510 may be more easily integrated with each other by configuring the spring member 570.

In addition, since the vibration driving apparatus 10 according to the embodiment of the present disclosure includes a spring member 570, vibration (or sound) generated by the vibration module 550 may be induced upward or toward the vibration member 100. In addition, since the vibration driving apparatus 10 according to the embodiment of the present disclosure includes a spring member 570, vibration (or sound) transmitted in the lower direction or the direction of the cover member 300 may be absorbed and buffered.

According to an embodiment of the present disclosure, the vibration driving apparatus 10 may further include a connection member 600. The connection member 600 may penetrate the cover member 300 and the base plate 511, and may connect or fix the vibration apparatus 500 to the cover member 300.

Accordingly, the connection member 600 may be configured in a partial area of the cover member 300 overlapping the extension portion 511a and the extension portion 511a of the base plate 511. The connection member 600 may be configured to penetrate a partial area of the cover member 300 overlapping the extension portion 511a and the extension portion 511a. The connection member 600 may be fastened to a partial area of the cover member 300 overlapping the extension portion 511a and the extension portion 511a.

According to an embodiment of the present disclosure, the connection member 600 may include a screw member 610 and a nut member 630. The screw member 610 may be configured to penetrate an extension part 511a and a partial area of the cover member 300 overlapping the extension part 511a. The nut member 630 may be configured on the base plate 511 and fastened to the screw member 610. The vibration apparatus 500 may be easily fastened to the cover member 300 by the screw member 610 and the nut member 630. For example, the nut member 630 may be a self-clinching nut or a PEM nut, and embodiments are not limited thereto. When the self-clinching nut is used, vibration generated in the vibration apparatus 500 may be partially absorbed by the self-clinching nut, and thus, vibration transmitted to the cover member 300 may be reduced.

According to an embodiment of the present disclosure, the vibration driving apparatus 10 may further include a middle frame 700.

The middle frame 700 may be disposed between a rear edge of the vibration member 100 and a front edge of the cover member 300. The middle frame 700 may support edges of each of the vibration member 100 and the cover member 300. The middle frame 700 may surround each side surface of at least one of the vibration member 100 and the cover member 300. A first gap space GS1 may be provided between the vibration member 100 and the cover member 300 by the middle frame 700. The first gap space GS1 may be expressed as an air gap, a vibration space, a vibration apparatus arrangement space, or the like, but is not limited thereto.

According to an embodiment of the present disclosure, the middle frame 700 may be formed of a metal material or a plastic material. For example, the middle frame 700 may be formed of a metal material to improve a side exterior design of the display apparatus and to protect the side surface of the display apparatus.

The middle frame 700 may be connected to or coupled to the rear edge of the vibration member 100 via a first coupling member 707. The middle frame 700 may be connected to or coupled to the front edge of the cover member 300 via a second coupling member 708. The front surface of the cover member 300 may be the other surface, the second surface, the upper surface, or the like, but is not limited thereto. The middle frame 700 may be expressed as a middle cabinet, a middle cover, a middle chassis, or the like, but is not limited thereto. Alternatively, the middle frame 700 may be integrally formed with the second cover member 350 and may be expressed as a second cover member 350.

According to an embodiment of the present disclosure, the middle frame 700 may include a support portion 710 and a sidewall portion 730. For example, the support portion 710 may be a first portion, and the sidewall portion 730 may be a second portion.

The support portion 710 may have a single frame structure of a square shape, but is not limited thereto. For example, the support portion 710 may have a shape of a plurality of split bars interposed between a rear edge of the vibration member 100 and a front edge of the cover member 300.

The support portion 710 may be interposed between the rear edge of the vibration member 100 and the front edge of the cover member 300, and thus, a gap space GS may be provided between the vibration member 100 and the cover member 300. A front surface of the support portion 710 may be connected to a rear edge of the vibration member 100 via a first coupling member 707. A rear surface of the support portion 710 may be connected to a front edge of the cover member 300 via a second coupling member 708. For example, the thickness of the support portion 710 may be set according to the thickness of the vibration apparatus 500 provided between the vibration member 100 and the cover member 300, the thickness of the first coupling member 707, and the thickness of the second coupling member 708.

The first coupling member 707 may be disposed between a rear edge of the vibration member 100 and a front surface of the support portion 710. For example, the first coupling member 707 may be an adhesive resin, a double-sided tape, or a double-sided adhesive foam pad, but is not limited thereto.

The second coupling member 708 is disposed between the front edge of the vibration member 300 and the rear surface of the support portion 710. For example, the second coupling member 708 may be an adhesive resin, a double-sided tape, or a double-sided adhesive foam pad, but is not limited thereto. For example, the first coupling member 707 and the second coupling member 708 may be formed of the same material or different materials.

The sidewall portion 730 may be vertically coupled to the outer side surface of the support portion 710 in parallel with the thickness direction Z of the vibration driving apparatus 10. The sidewall portion 730 may surround both the outer side surface (or outer sidewall) of the vibration member 100 and the outer side surface (or outer sidewall) of the cover member 300. Accordingly, the outer side surface of each of the vibration member 100 and the cover member 300 may be protected, and an outer design of the side surface of the vibration driving apparatus 10 may be improved.

The vibration driving apparatus 10 according to another embodiment of the present disclosure may include an adhesive member instead of the middle frame 700. The adhesive member may be interposed between the rear edge of the vibration member 100 and the front edge of the cover member 300, and thus, a gap space GS may be provided between the vibration member 100 and the cover member 300.

Accordingly, the vibration driving apparatus 10 according to an embodiment of the present disclosure may output the sound PVS to the front FD of the display panel 100 by one or more vibration apparatus 500 disposed between the vibration member 100 and the cover member 300. Accordingly, the immersion of the viewer watching the image of the display apparatus may be improved.

In addition, the vibration driving apparatus 10 according to an embodiment of the present disclosure does not need to configure an additional speaker because sound PVS is generated by vibration of the display panel 110. Accordingly, the design of the set device and the degree of freedom in speaker placement can be improved.

The vibration driving apparatus 10 according to the embodiment of the present disclosure includes a vibration apparatus 500 in which the sound generating module 510 and the vibration module 550 are integrated, and thus, the acoustic characteristics and/or sound pressure characteristics of the mid-low and mid-high ranges may be improved.

In addition, the vibration driving apparatus 10 according to the embodiment of the present disclosure includes a vibration apparatus 500 in which the sound generating module 510 and the vibration module 550 are integrated, and thus, similar low-mid and mid-high range acoustic and/or sound pressure characteristics can be implemented at all attachment locations of the vibration apparatus 500.

In addition, the vibration driving apparatus 10 according to the embodiment of present disclosure includes a vibration apparatus 500 in which the sound generating module 510 and the vibration module 550 are integrated, and thus, multi-panel sound can be implemented, and there is the effect of uni-materialization.

In addition, the vibration driving apparatus 10 according to the embodiment of present disclosure includes a vibration apparatus 500 in which the sound generating module 510 and the vibration module 550 are integrated, and thus, the structure of the vibration driving apparatus 10 can be simplified and manufacturing costs can be reduced.

In addition, the vibration driving apparatus 10 according to the embodiment of the present disclosure includes a spring member 570, and thus, the vibration module 550 may be more easily connected to the rear surface of the vibration member 100.

FIG. 5 is a diagram illustrating a vibration module according to an embodiment of the present disclosure. FIG. 6 is a cross-sectional view taken along the line II-II′ shown in FIG. 5 according to an embodiment of the present disclosure. FIGS. 5 and 6 show the vibration module and the signal supply member of the vibration apparatus described with reference to FIGS. 1 to 4.

Referring to FIGS. 5 and 6, the vibration module 550 according to an embodiment of the present disclosure may include a piezoelectric material having piezoelectric characteristics. The vibration module 550 may be formed of a ceramic-based piezoelectric material capable of implementing relatively high vibration, or may be formed of a piezoelectric ceramic having a perovskite-based crystal structure. For example, the vibration module 550 may be a vibration generating device, a vibration film, a vibration generating film, a vibrator, a vibration generator, an active vibrator, an active vibration generator, an actuator, an exciter, a film actuator, a film exciter, an ultrasonic actuator, or an active vibration member, or the like, but embodiments of the present disclosure are not limited thereto.

The vibration module 550 according to an embodiment of the present disclosure may include a vibration generating portion 551.

The vibration generating portion 551 may be configured to vibrate by a piezoelectric effect according to a driving signal. The vibration generating portion 551 may include at least one of a piezoelectric inorganic material and a piezoelectric organic material. For example, the vibration generating portion 551 may be a vibration device, a piezoelectric device, a piezoelectric device unit, a piezoelectric device layer, a piezoelectric structure, a piezoelectric vibration unit, a piezoelectric vibration layer, or the like, and embodiments of the present disclosure are not limited thereto.

The vibration generating portion 551 according to an embodiment of the present disclosure may include a vibration layer 551a, a first electrode layer 551b, and a second electrode layer 551c.

The vibration layer 551a may include a piezoelectric material or an electroactive material having a piezoelectric effect. For example, the piezoelectric material can have a characteristic in which, when pressure or twisting phenomenon is applied to a crystalline structure by an external force, a potential difference occurs due to dielectric polarization caused by a relative position change of a positive (+) ion and a negative (−) ion, and thus a vibration is generated by an electric field based on a reverse voltage applied thereto. For example, the vibration layer 551a may be a piezoelectric layer, a piezoelectric material layer, an electroactive layer, a piezoelectric composite layer, a piezoelectric composite, a piezoelectric ceramic composite, or the like, and embodiments of the present disclosure are not limited thereto.

The vibration layer 551a can be configured as a ceramic-based material capable of implementing a relatively strong vibration, or can be configured as a piezoelectric ceramic having a perovskite-based crystalline structure. The perovskite crystalline structure can have a piezoelectric effect and/or an inverse piezoelectric effect and can be a plate-shaped structure having orientation or alignment.

The piezoelectric ceramic can be configured as a single crystalline ceramic having a crystalline structure, or can be configured as a ceramic material having a polycrystalline structure or polycrystalline ceramic. The piezoelectric material of the single crystal ceramic may include a lead zirconate titanate PZT-based materials containing lead (Pb), zirconium (Zr), and titanium (Ti), a lead zirconate nickel niobate PZNN materials containing lead (Pb), zirconium (Zr), nickel (Ni), and niobium (Nb), α-AlPO₄, α-SiO₂, LiNbO₃, Tb₂(MoO₄)₃, Li₂B₄O₇, ZnO, CaTiO₃, BaTiO₃, (K,Na)NbO₃, or SrTiO₃, but embodiments of the present specification are not limited thereto. The piezoelectric material of the polycrystalline ceramic may include a lead zirconate titanate PZT-based materials containing lead (Pb), zirconium (Zr), and titanium (Ti), or a lead zirconate nickel niobate PZNN materials containing lead (Pb), zirconium (Zr), nickel (Ni), and niobium (Nb), but embodiments of the present specification are not limited thereto. For example, the vibration layer 551a may include at least one of CaTiO₃, BaTiO₃, (K, Na)NbO₃, and SrTiO₃, which do not contain lead (Pb), but embodiments of present disclosure are not limited thereto.

The first electrode layer 551b may be disposed on the first surface (or upper surface or front surface) 551s1 of the vibration layer 551a. The first electrode layer 551b may have the same size as the vibration layer 551a or may have a smaller size than the vibration layer 551a.

The second electrode layer 551c may be disposed on a second surface (or a lower surface or a rear surface) 551s2 that is different from or opposite to the first surface 551s1 of the vibration layer 551a. The second electrode layer 551c may have the same size as the vibration layer 551a or may have a smaller size than the vibration layer 551a. For example, the second electrode layer 551c may have the same shape as the vibration layer 551a, but embodiments of the present disclosure are not limited thereto.

According to an embodiment of the present disclosure, in order to prevent an electrical connection (or short circuit) between the first electrode layer 551b and the second electrode layer 551c, each of the first electrode layer 551b and the second electrode layer 551c may be formed on the entire portion except for an edge portion of the vibration layer 551a. For example, the first electrode layer 551b may be formed on the entire portion of the remaining portion of the first surface 551s1a except for an edge portion thereof. For example, the second electrode layer 551c may be formed on the entire portion of the second surface 551s2 of the vibration layer 551a except for an edge portion thereof. For example, a distance between a side surface (or outer sidewall) of each of the first electrode layer 551b and the second electrode layer 551c and a side surface (or outer sidewall) of the vibration layer 551a may be at least 0.1 mm or more. For example, a distance between a side surface of each of the first electrode layer 551b and the second electrode layer 551c and a side surface of the vibration layer 551a may be at least 0.5 mm or more, but embodiments of the present disclosure are not limited thereto.

According to an embodiment of the present disclosure, at least one of the first electrode layer 551b and the second electrode layer 551c may be formed of a transparent conductive material, a translucent conductive material, or an opaque conductive material. For example, the transparent or translucent conductive material may include indium tin oxide (ITO) or indium zinc oxide (IZO), but embodiments of the present disclosure are not limited thereto. The opaque conductive material may include gold (Au), silver (Ag), platinum (Pt), palladium (Pd), molybdenum (Mo), magnesium (Mg), carbon (C), copper (Cu), nickel (Ni), silver including a glass frit, or the like, but embodiments of the present disclosure are not limited thereto. For example, each of the first electrode layer 551b and the second electrode layer 551c may include silver (Ag) having a low specific resistance in order to improve electrical characteristics and/or vibration characteristics of the vibration layer 551a. For example, carbon may be a carbon material including carbon black, ketjen black, carbon nanotubes, and graphite, but embodiments of the present disclosure are not limited thereto.

The vibration layer 551a may be polarized (or polling) by a constant voltage applied to the first electrode layer 551b and the second electrode layer 551c in a constant temperature atmosphere or a temperature atmosphere changed from high temperature to room temperature, but embodiments of the present disclosure are not limited thereto. For example, the polarization direction (or the polling direction) formed in the vibration layer 551a may be formed or oriented (or arranged) from the first electrode layer 551b to the second electrode layer 551c, but is not limited thereto. For another example, the polarization direction (or the polling direction) formed in the vibration layer 551a may be formed or oriented (or arranged) from the second electrode layer 551c to the first electrode layer 551b.

The vibration layer 551a may vibrate by alternately repeating contraction and/or expansion by a reverse piezoelectric effect by a driving signal applied to the first electrode layer 551b and the second electrode layer 551c from the outside. For example, the vibration layer 551a may vibrate in a vertical direction (or a thickness direction) and a plane direction by a signal applied to the first electrode layer 551b and the second electrode layer 551c. The vibration layer 551a may be displaced (or vibrated or driven) by contraction and/or expansion in both the plane and the vertical direction, and thus, vibration characteristic including acoustic characteristics and/or sound pressure characteristics of the vibration module 550 may be improved.

According to an embodiment of the present disclosure, the vibration module 550 may further include a first cover member 553a and a second cover member 553d.

The first cover member 553a may be disposed on a first surface of the vibration generating portion 551. For example, the first cover member 553a may be configured to cover the first electrode layer 551b of the vibration generating portion 551. For example, the first cover member 553a may be configured to have a size larger than that of the vibration generating portion 551. The first cover member 553a may be configured to protect the first surface of the vibration generating portion 551 and the first electrode layer 551b.

The second cover member 553d may be disposed on the second surface of the vibration generating portion 551. For example, the second cover member 553d may be configured to cover the second electrode layer 551c of the vibration generating portion 551. For example, the second cover member 553d may be configured to have a size larger than that of the vibration generating portion 551, and may be configured to have the same size as that of the first cover member 553a. The second cover member 553d may be configured to protect the second surface and the second electrode layer 551c of the vibration generating portion 551.

According to an embodiment of the present disclosure, the first cover member 553a and the second cover member 553d may include the same material or different materials. For example, each of the first cover member 553a and the second cover member 553d may be a polyimide film or a polyethylene terephthalate film, but embodiments of the present disclosure are not limited thereto.

The first cover member 553a may be connected to or coupled to the first surface of the vibration generating portion 551 or the first electrode layer 551b via the first adhesive layer 553b. For example, the first cover member 553a may be connected to or coupled to the first surface of the vibration generating portion 551 or the first electrode layer 551b by a film laminating process using the first adhesive layer 553b.

The second cover member 553d may be connected to or coupled to the second surface or the second electrode layer 551c of the vibration generating portion 551 via the second adhesive layer 553c. For example, the second cover member 553d may be connected to or coupled to the second surface or the second electrode layer 551c of the vibration generating portion 551 by a film laminating process using the second adhesive layer 553c.

According to an embodiment of the present disclosure, each of the first adhesive layer 553b and the second adhesive layer 553c may include an electrical insulating material having an adhesive property, which may be compressed and restored. For example, each of the first adhesive layer 553b and the second adhesive layer 553c may include an epoxy resin, an acrylic resin, a silicone resin, or a urethane resin, but embodiments of the present disclosure are not limited thereto.

The first adhesive layer 553b and the second adhesive layer 553c may be configured between the first cover member 553a and the second cover member 553d to surround the vibration generating portion 551. For example, at least one of the first adhesive layer 553b and the second adhesive layer 553c may be configured to surround the vibration generating portion 551.

Any one of the first cover member 553a and the second cover member 553d may be connected to or coupled to the vibration member 100 via the second adhesive member 420 illustrated in FIGS. 2 and 3. For example, the first cover member 553a, the second cover member 553d, the first adhesive layer 553b, and the second adhesive layer 553c may be partially omitted depending on the configuration of the vibration generating portion 511. For example, for connection with the vibration member 100, the cover member and the adhesive layer may be configured only on one surface of the vibration generating portion 551. For another example, for connection with the vibration member 100, the adhesive layer may be configured only on one surface of the vibration generating portion 551.

The vibration apparatus 500 according to an embodiment of the present disclosure may further include a signal supply member 580.

The signal supply member 580 may be configured to supply a driving signal supplied from the driving circuit portion to the vibration generating portion 551. The signal supply member 580 may be configured to be electrically connected to the vibration generating portion 551. The signal supply member 580 may be configured to be electrically connected to the first and second electrode layers 551b and 551c of the vibration generating portion 551.

A part of the signal supply member 580 may be accommodated (or inserted) between the first cover member 553a and the second cover member 553d. An end portion (or a terminal portion or one side) of the signal supply member 580 may be disposed or inserted (or accommodated) between one edge portion of the first cover member 553a and one edge portion of the second cover member 553d. One edge portion of the first cover member 553a and one edge portion of the second cover member 553d may accommodate or vertically cover the end portion (or a terminal portion or one side) of the signal supply member 580. Accordingly, the signal supply member 580 may be integrated with the vibration generating portion 510. For example, the signal supply member 580 may include a signal cable, a flexible cable, a flexible printed circuit cable, a flexible flat cable, a single-sided flexible printed circuit, a single-sided flexible printed circuit board, a flexible multilayer printed circuit, or a flexible multilayer printed circuit board, but embodiments of the present disclosure are not limited thereto. As another example, the signal supply member 580 may be connected to the vibration generating portion 551 by soldering.

The signal supply member 580 according to an embodiment of the present disclosure may include a base member 585, and a plurality of signal lines 583a and 583b. For example, the signal supply member 580 may include a base member 585, a first signal line 583a, and a second signal line 583b.

The base member 585 may include a transparent or opaque plastic material, but embodiments of the present disclosure are not limited thereto. The base member 585 has a constant width in the first direction X and may extend long in the second direction Y crossing the first direction X.

The first and second signal lines 583a and 583b are disposed on the first surface of the base member 585 in parallel with the second direction Y, and may be spaced apart from each other or electrically separated from each other along the first direction X. The first and second signal lines 583a and 583b may be disposed parallel to each other on the first surface of the base member 585. For example, the first and second signal lines 583a and 583b may be formed in a line shape by patterning of a metal layer (or conductive layer) formed or deposited on the first surface of the base member 585.

End portions (or a terminal portion or one side) of the first and second signal lines 583a and 583b may be individually flexed or bent by being separated from each other.

End portions (or a terminal portion or one side) of the first signal line 583a may be electrically connected to the first electrode layer 551b of the vibration generating portion 551. For example, an end portion of the first signal line 583a may be electrically connected to at least a portion of the first electrode layer 551b of the vibration generating portion 551 at an edge portion of one side of the first cover member 553a. For example, an end portion (or a terminal portion or one side) of the first signal line 583a may be directly electrically connected to at least a portion of the first electrode layer 551b of the vibration generating portion 551. For example, an end portion (or a terminal portion or one side) of the first signal line 583a may be directly connected to or in direct contact with the first electrode layer 551b of the vibration generating portion 551. Accordingly, the first signal line 583a can supply the first driving signal, which is provided from the vibration driving portion, to the first electrode layer 551b of the vibration generating portion 551.

End portions (or a terminal portion or one side) of the second signal line 583b may be electrically connected to the second electrode layer 551c of the vibration generating portion 551. For example, an end portion of the second signal line 583b may be electrically connected to at least a portion of the second electrode layer 551c of the vibration generating portion 551 at an edge portion of one side of the second cover member 553d. For example, an end portion (or a terminal portion or one side) of the second signal line 583b may be directly electrically connected to at least a portion of the second electrode layer 551c of the vibration generating portion 551. For example, an end portion (or a terminal portion or one side) of the second signal line 583b may be directly connected to or in direct contact with the second electrode layer 551c of the vibration generating portion 551. Accordingly, the second signal line 583b can supply the second driving signal, which is provided from the vibration driving portion, to the second electrode layer 551c of the vibration generating portion 551.

According to an embodiment of the present disclosure, a part of the signal supply member 580 or a part of the base member 585 is disposed or inserted (or accommodated) between the first cover member 583a and the second cover member 583d, and thus, the signal supply member 580 may be integrated with the vibration generating portion 551. Accordingly, the vibration generating portion 551 and the signal supply member 580 may be configured as a single component, thereby having an effect of uni-materialization.

According to an embodiment of the present disclosure, since the first signal line 583a and the second signal line 583b of the signal supply member 580 are integrated with the vibration generating portion 551, a soldering process for electrical connection between the vibration generating portion 551 and the signal supply member 580 may not be required. Accordingly, the structure and manufacturing process of the vibration module 550 may be simplified. Accordingly, the vibration driving apparatus according to the embodiment of the present disclosure has an effect of improving a harmful process.

According to another embodiment of the present disclosure, the vibration module 500 may include two or more vibration generating portion 551. For example, the vibration module 550 may include a first vibration generating portion and a second vibration generating portion, which are stacked.

In order to maximize the amplitude displacement of the vibration module 550 and/or the amplitude displacement of the vibration member, the first vibration generating portion and the second vibration generating portion may be overlapped or stacked to be displaced (or driven or vibrated) in the same direction. For example, the first vibration generating portion and the second vibration generating portion may have substantially the same size, but embodiments of the present disclosure are not limited thereto. A configuration of each of the first vibration generating portion and the second vibration generating portion may be substantially the same as that of the vibration generating portion 551.

According to another embodiment of the present specification, the vibration module 550 may include two or more vibration generating portion stacked (or overlapping) to vibrate (or displace or drive) in the same direction, and thus, amount of displacement or amplitude displacement can be maximized or increased. Accordingly, the displacement amount (or bending or driving force) or amplitude displacement of the vibration member may be maximized or increased.

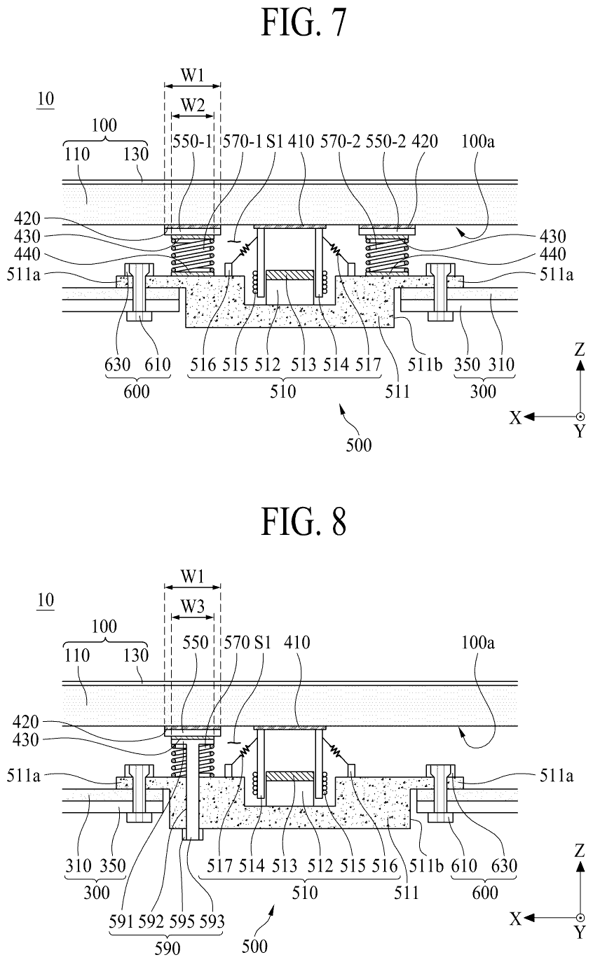

FIG. 7 is a cross-sectional view of a vibration apparatus according to another embodiment of the present disclosure. FIG. 7 shows that the vibration driving apparatus according to the embodiment of the present disclosure, described with reference to FIGS. 1 to 4, includes a plurality of vibration modules and a plurality of spring members. Other configurations, except for the plurality of vibration modules and the plurality of spring members, are substantially the same as those of the embodiment of the present disclosure. Accordingly, hereinafter, the same reference numerals will be used for substantially identical configurations, and redundant explanations will be briefly described or omitted.

Referring to FIG. 7, a vibration driving apparatus 10 according to another embodiment of the present disclosure may include a plurality of vibration modules 550. For example, the vibration driving apparatus 10 may include a first vibration module 550-1 and a second vibration module 550-2.

According to another embodiment of the present disclosure, each of the first vibration module 550-1 and the second vibration module 550-2 may be provided between the vibration member 100 and the sound generating module 510. Each of the first vibration module 550-1 and the second vibration module 550-2 may be provided between the vibration member 100 and the base plate 511 of the sound generating module 510. Each of the first vibration module 550-1 and the second vibration module 550-2 may be connected to the rear surface or the first surface 100a of the vibration member 100. The first vibration module 550-1 and the second vibration module 550-2 may be connected to the sound generating module 510. According to another embodiment of the present disclosure, the first vibration module 550-1 may be provided on the rear surface of the vibration member 100 or between the first surface 100a and one side of the base plate 511. The second vibration module 550-2 may be provided on the rear surface of the vibration member 100 or between the first surface 100a and the other side opposite to one side of the base plate 511. Each of the first vibration module 550-1 and the second vibration module 550-2 may be configured on one side and the other side of the base plate 511 to be spaced apart from the magnet 512, the bobbin 514, and the coil 515. Each of the first vibration module 550-1 and the second vibration module 550-2 may have the same configuration as the vibration module 500 described with reference to FIGS. 1 to 4.

A second adhesive member 420 may be configured between the vibration member 100 and the first vibration module 550-1 and between the vibration member 100 and the second vibration module 550-2. For example, the first vibration module 550-1 may be connected to the vibration member 100 via a second adhesive member 420. For example, the second vibration module 550-2 may be connected to the vibration member 100 via a second adhesive member 420.

According to another embodiment of the present disclosure, the vibration apparatus 500 may include a plurality of spring members 570. Each of a plurality of spring members 570 may be disposed to correspond to the first vibration module 550-1 and the second vibration module 550-2. A plurality of spring members 570 may include a first spring member 570-1 and a second spring member 570-2.

The first spring member 570-1 may be provided between the first vibration module 550-1 and the sound generating module 510. The first spring member 570-1 may be provided on a rear surface of the first vibration module 550-1 and an upper surface of one side of the base plate 511. The first spring member 570-1 may support the first vibration module 550-1 between the rear surface of the first vibration module 550-1 and one side of the base plate 511. The first spring member 570-1 may guide the traveling direction of the first vibration module 550-1 so that the first vibration module 550-1 is easily attached to the vibration member 100 by the elastic force of the first spring member 570-1 between the rear surface of the first vibration module 550-1 and one side of the base plate 511. A third adhesive member 430 may be provided between a rear surface of the first vibration module 550-1 and an upper end of the first spring member 570-1. The first vibration module 550-1 and the first spring member 570-1 may be connected via a third adhesive member 430. A fourth adhesive member 440 may be provided between an upper surface of the sound generating module 510 or the base plate 511 and a lower end of the first spring member 570-1. The upper surface of the sound generating module 510 or the base plate 511 and the first spring member 570-1 may be connected to each other via a fourth adhesive member 440.

The second spring member 570-2 may be provided between the second vibration module 550-2 and the sound generating module 510. The second spring member 570-2 may be provided on the rear surface of the second vibration module 550-2 and the upper surface of the other side of the base plate 511. The second spring member 570-2 may support the second vibration module 550-2 between the rear surface of the second vibration module 550-2 and the other side of the base plate 511. The second spring member 570-2 may guide the traveling direction of the second vibration module 550-2 so that the second vibration module 550-2 is easily attached to the vibration member 100 by the elastic force of the second spring member 570-2 between the rear surface of the second vibration module 550-2 and the other side of the base plate 511. A third adhesive member 430 may be provided between the rear surface of the second vibration module 550-2 and the upper end of the second spring member 570-2. The second vibration module 550-2 and the second spring member 570-2 may be connected to each other via a third adhesive member 430. A fourth adhesive member 440 may be provided between an upper surface of the sound generating module 510 or the base plate 511 and a lower end of the second spring member 570-2. The upper surface of the sound generating module 510 or the base plate 511 and the second spring member 570-2 may be connected to each other via a fourth adhesive member 430. Each of the first spring member 570-1 and the second spring member 570-2 according to another embodiment of the present disclosure may have the same structure and material as those of the spring member 570 described with reference to FIGS. 1 to 4.

The vibration driving apparatus 10 according to another embodiment of the present disclosure may implement the same effect as the embodiment of the present disclosure.

According to another embodiment of the present disclosure, the vibration driving apparatus 10 includes a vibration apparatus 500 in which a sound generating module 510 and a plurality of vibration modules 550 are integrated, thereby further improving the acoustic characteristics and/or sound pressure characteristics of the mid and low ranges.

In addition, the vibration driving apparatus 10 according to the embodiment of the present disclosure includes a plurality of spring members 570 connected to each of the plurality of vibration modules 550, so that the vibration module 550 may be more easily connected to the rear surface of the vibration member 100 and the base plate 511.

FIG. 8 is a cross-sectional view of a vibration apparatus according to another embodiment of the present disclosure. FIG. 8 shows that a configuration of a guide member is added to the vibration driving apparatus according to an embodiment of the present disclosure described with reference to FIG. 4. Other configurations, except for the guide member, are substantially the same as those of the embodiment of the present disclosure. Accordingly, hereinafter, the same reference numerals will be used for substantially identical configurations, and redundant explanations will be briefly described or omitted.

Referring to FIG. 8, a vibration apparatus 500 according to another embodiment of the present disclosure may further include a guide member 590. The guide member 590 may be connected to the vibration module 550 to guide the spring member 570. The guide member 590 may have a ‘T’ shape. The guide member 590 may be connected to the rear surface of the vibration module 550 via a third adhesive member 430. The guide member 590 may be inserted into the spring member 570. The guide member 590 may include a guide support portion 591, a guide portion 592, a protrusion portion 593, and a fastening portion 595.

The guide support portion 591 may be connected to the rear surface of the vibration module 550 to support the rear surface of the vibration module 550. The guide support portion 591 may have a plate shape extending from the guide portion 592 and horizontally protruding to the outer periphery of the guide portion 592. The guide support portion 591 may have a size equal to or smaller than that of the vibration module 550. For example, the width W3 of the guide support portion 591 may be equal to or smaller than the width W1 of the vibration module 550, but the present disclosure is not limited thereto. For example, the guide support portion 591 may have a size equal to or less than 90% of the vibration module 550.

The guide portion 592 is connected to the guide support portion 591 and may guide compression and restoration of the spring member 570. The guide portion 592 may extend vertically from a center of the guide support portion 591. The spring member 570 may be disposed on the guide portion 592. The spring member 570 may be wound on the guide portion 592.

The protrusion portion 593 may extend from the guide portion 592 to penetrate one side of the base plate 511 and protrude outward from the base plate 511. For example, one side of the base plate 511 may be configured with an insertion hole into which the protrusion portion 593 is inserted.

The fastening portion 595 may be fastened to the protruding portion 593. The guide member 590 may be connected to or fixed to the sound generating module 510 by the protruding portion 593 and the fastening portion 595. The guide member 590 may be easily fastened to one side of the base plate 511 by the protruding portion 593 and the fastening portion 595. For example, the fastening portion 595 may be a self-clinching nut or a PEM nut, but the embodiment is not limited thereto. For example, the guide member 590 may be made of a metal material such as SUS or aluminum (Al).

For example, when the vibration member 100, the vibration apparatus 500, and the cover member 300 are connected, the spring member 570 is compressed, and the protrusion portion 593 may protrude from an insertion hole formed at one side of the base plate 511. The fastening portion 595 is fastened to the protruding protrusion portion 593, and thus, the vibration member 100, the vibration device 500, and the cover member 300 may be easily connected.

Accordingly, the vibration driving apparatus 10 according to another embodiment of the present disclosure includes a guide member 590, so that the spring member 570 may be prevented from vibrating by vibration when the sound generation module 510 vibrates up and down. Accordingly, the vibration driving apparatus 10 according to another embodiment of the present disclosure includes a guide member 590, and thus, mutual interference between the vibration module 550 and the sound generation module 510 may be further prevented.

According to another embodiment of the present disclosure, the guide member 590 may include the same material as the vibration module 550. For example, the guide member 590 may include a piezoelectric material including a piezoelectric effect, a composite piezoelectric material, or an electroactive material. Accordingly, the guide member 590 may have the same rigidity as that of the vibration module 550. Accordingly, the guide member 590 does not add an additional manufacturing process, and work efficiency may be improved. In addition, the guide member 590 has the same rigidity as that of the vibration module 550, and thus, the frequency of the vibration module 550 may be easily controlled.

The vibration driving apparatus 10 according to another embodiment of the present disclosure may implement the same effect as the embodiment of the present disclosure.

According to another embodiment of the present disclosure, the vibration driving apparatus 10 includes a spring member 570 and a guide member 590, and thus, the vibration module 550 may be more easily integrated with the sound generating module 510.

According to another embodiment of the present disclosure, the vibration driving apparatus 10 includes a spring member 570 and a guide member 590, and thus, the vibration module 550 may be more easily connected to the first surface 100a of the vibration member 100.

In another embodiment of the present disclosure, the vibration driving apparatus 10 according to the present disclosure is described as an example in which one spring member 570 and one guide member 590 are configured in one vibration module 550, but the present disclosure is not limited thereto. For example, the vibration module 500 may include a first vibration module and a second vibration module as shown in FIG. 7. For example, the spring member 570 and the guide member 590 may be configured in the first vibration module and the second vibration module, respectively. The spring member 570 and the guide member 590 configured in each of the first vibration module and the second vibration module include the same material, and may have the same configuration and effect.

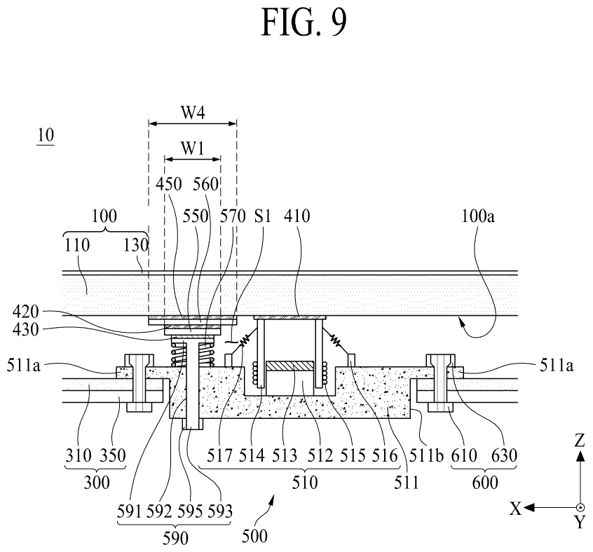

FIG. 9 is a cross-sectional view of a vibration apparatus according to another embodiment of the present disclosure. FIG. 9 shows that a dummy plate configuration is added to the vibration driving apparatus according to an embodiment of the present disclosure described with reference to FIG. 8. Other configurations, except for the dummy plate, are substantially the same as those of the embodiment of the present disclosure. Accordingly, hereinafter, the same reference numerals will be used for substantially identical configurations, and redundant explanations will be briefly described or omitted.

Referring to FIG. 9, a vibration apparatus 500 according to another embodiment of the present disclosure may further include a dummy plate 560. The dummy plate 560 may be disposed between the vibration member 100 and the vibration module 550. The dummy plate 560 may be adhered to the first surface 100a of the vibration member 100 via a fifth adhesive member 450. The dummy plate 560 may be adhered to the upper surface of the vibration module 550 via a second adhesive member 420.

According to an embodiment of the present disclosure, the dummy plate 560 may have a size equal to or larger than that of the vibration module 550. For example, a width W4 of the dummy plate 560 may be equal to or greater than a width W1 of the vibration module 500. For another example, the dummy plate 560 may have a size smaller than that of the vibration module 550. For example, the dummy plate 560 may have a size of 80% to 120% of the vibration module 550. The dummy plate 560 may include a metal material or a plastic material. A metal material of the dummy plate 560 may include at least one of stainless steel, copper (Cu), a copper (Cu) alloy, a tungsten (W), a tungsten (W) alloy, an aluminum (Al), an aluminum (Al) alloy, a magnesium (Mg), a magnesium (Mg) alloy, and a magnesium lithium (Mg—Li) alloy, but embodiments of the present disclosure are not limited thereto. For example, the dummy plate 560 may be made of an aluminum metal material or a plastic or styrene material, but embodiments of the present disclosure are not limited thereto. For example, the styrene material may be an ABS material. The ABS material may be acrylonitrile, butadiene, and styrene. For example, the dummy plate 560 may be carbon fiber reinforced plastic CFRP, polypropylene, polycarbonate, or the like, but embodiments of the present disclosure are not limited thereto. For example, the dummy plate 560 may be a dummy plate, an auxiliary member, an auxiliary plate, a high-pitched reinforced member, or a high-pitched reinforced plate, but embodiments of the present disclosure are not limited thereto.

According to another embodiment of the present disclosure, the rigidity of the vibration member 100 may be increased by additionally configuring the dummy plate 560. Accordingly, in the vibration driving apparatus 10 according to another embodiment of the present disclosure, the rigidity of the vibration member 100 is increased, and thus, the vertical amplitude of the vibration may be improved. Accordingly, the acoustic characteristics and/or sound pressure characteristics in the high-pitched range may be further improved.

The features of the vibration driving apparatus according to an embodiment of the present disclosure are briefly summarized as follows.

According to one or more embodiments of the present disclosure, a vibration driving apparatus may comprise a vibration member, and a vibration apparatus configured to vibrate the vibration member. The vibration apparatus may include a sound generating module, a vibration module connected to the sound generating module, and a spring member between the sound generating module and the vibration module.

According to one or more embodiments of the present disclosure, each of the sound generating module and the vibration module may be connected to the first surface of the vibration member.

According to one or more embodiments of the present disclosure, the spring member may connect the sound generating module to the vibration module.

According to one or more embodiments of the present disclosure, a width of the spring member may be smaller than a width of the vibration module.

According to one or more embodiments of the present disclosure, the spring member may have a spring constant of 50 N/m or less.

According to one or more embodiments of the present disclosure, the sound generating module may include a coil-type sound generating module.

According to one or more embodiments of the present disclosure, the vibration module may include a piezoelectric material.

According to one or more embodiments of the present disclosure, the vibration driving apparatus may further comprise a first adhesive member that adheres to the vibration member and the sound generating module, a second adhesive member that adheres to the vibration member and the vibration module, a third adhesive member that adheres to the vibration module and the spring member, and a fourth adhesive member that adheres to the spring member and the sound generating module.

According to one or more embodiments of the present disclosure, the sound generating module may include a base plate, a magnet on the base plate, a bobbin surrounding the magnet, and a coil wound around the bobbin. The vibration module may be configured between the vibration member and the base plate.

According to one or more embodiments of the present disclosure, the spring member may be configured between the vibration module and the base plate.

According to one or more embodiments of the present disclosure, the vibration module and the spring member may be configured at one side of the base plate to be spaced apart from the magnet, the bobbin, and the coil.

According to one or more embodiments of the present disclosure, the vibration module may include a first vibration module configured on one side of the base plate to be spaced apart from the magnet, the bobbin, and the coil, and a second vibration module configured on the other side of the base plate to be spaced apart from the magnet, the bobbin, and the coil.

According to one or more embodiments of the present disclosure, the spring member may include a first spring member connected to the first vibration module and configured on one side of the base plate to be spaced apart from the magnet, the bobbin, and the coil, and a second spring member connected to the second vibration module and configured on the other side of the base plate to be spaced apart from the magnet, the bobbin, and the coil. With respect to this paragraph, the preceding four paragraphs, and similar contexts elsewhere, in one or more examples, the term “configured on” may refer to “configured at,” and the term “configured” may refer to “arranged,” “disposed,” “placed,” “located,” “positioned,” or the like.

According to one or more embodiments of the present disclosure, the vibration driving apparatus may further comprise a guide member connected to the vibration module to guide the spring member. The guide member may include the same material as the vibration module.

According to one or more embodiments of the present disclosure, the guide member may include a guide support portion that supports a rear surface of the vibration module, a guide portion that is connected to the guide support portion and guides the spring member, a protruding portion extending from the guide portion, penetrating the base plate, and protruding outside the base plate, and a fastening portion fastened to the protrusion portion.

According to one or more embodiments of the present disclosure, the spring member may be wound around the guide portion.

According to one or more embodiments of the present disclosure, the vibration module may include a vibration layer including piezoelectric materials, a first electrode layer on a first surface of the vibration layer, and a second electrode layer on a second surface different from the first surface of the vibration layer.

According to one or more embodiments of the present disclosure, the vibration driving apparatus may further comprise a dummy plate between the vibration member and the vibration module.

According to one or more embodiments of the present disclosure, the dummy plate may have a size equal to or larger than a size of the vibration module.

According to one or more embodiments of the present disclosure, the vibration apparatus may include a first vibration apparatus and a second vibration apparatus disposed parallel to each other on a first surface of the vibration member. The first vibration apparatus and the second vibration apparatus may be the same vibration apparatus.

The above-described feature, structure, and effect of the present disclosure are included in at least one embodiment of the present disclosure, but are not limited to only one embodiment. Furthermore, the feature, structure, and effect described in at least one embodiment of the present disclosure can be implemented through combination or modification of other embodiments by those skilled in the art. Therefore, content associated with the combination and modification should be construed as being within the scope of the present disclosure.

It will be apparent to those skilled in the art that various modifications and variations can be made in the present disclosure without departing from the spirit or scope of the disclosures. Thus, it is intended that the present disclosure covers the modifications and variations of this disclosure provided they come within the scope of the present disclosure. The scope of protection of the present disclosure should be construed based on the following claims, and all technical features within the scope of equivalents thereof should be construed as being included within the scope of the present disclosure.

What is claimed is:

1. A vibration driving apparatus, comprising:
a vibration member; and
a vibration apparatus configured to vibrate the vibration member,
wherein the vibration apparatus includes:
a sound generating module;
a vibration module connected to the sound generating module; and
a spring member between the sound generating module and the vibration module.

2. The vibration driving apparatus of claim 1, wherein each of the sound generating module and the vibration module is connected to a first surface of the vibration member.

3. The vibration driving apparatus of claim 1, wherein the spring member connects the sound generating module to the vibration module.

4. The vibration driving apparatus of claim 1, wherein a width of the spring member is smaller than a width of the vibration module.

5. The vibration driving apparatus of claim 1, wherein the spring member has a spring constant of 50 N/m or less.

6. The vibration driving apparatus of claim 1, wherein the sound generating module includes a coil-type sound generating module.

7. The vibration driving apparatus of claim 1, wherein the vibration module includes a piezoelectric material.

8. The vibration driving apparatus of claim 1, further comprising:
a first adhesive member that adheres to the vibration member and the sound generating module;
a second adhesive member that adheres to the vibration member and the vibration module;
a third adhesive member that adheres to the vibration module and the spring member; and
a fourth adhesive member that adheres to the spring member and the sound generating module.

9. The vibration driving apparatus of claim 1, wherein the sound generating module includes:
a base plate;
a magnet on the base plate;
a bobbin surrounding the magnet; and
a coil wound around the bobbin, and
wherein the vibration module is disposed between the vibration member and the base plate.

10. The vibration driving apparatus of claim 9, wherein the spring member is configured between the vibration module and the base plate.

11. The vibration driving apparatus of claim 9, wherein the vibration module and the spring member are configured at one side of the base plate to be spaced apart from the magnet, the bobbin, and the coil.

12. The vibration driving apparatus of claim 9, wherein the vibration module includes:
a first vibration module configured on one side of the base plate to be spaced apart from the magnet, the bobbin, and the coil; and
a second vibration module configured on the other side of the base plate to be spaced apart from the magnet, the bobbin, and the coil.

13. The vibration driving apparatus of claim 12, wherein the spring member includes:
a first spring member connected to the first vibration module and configured on one side of the base plate to be spaced apart from the magnet, the bobbin, and the coil; and
a second spring member connected to the second vibration module and configured on the other side of the base plate to be spaced apart from the magnet, the bobbin, and the coil.

14. The vibration driving apparatus of claim 9, further comprising:
a guide member connected to the vibration module to guide the spring member,
wherein the guide member includes the same material as the vibration module.

15. The vibration driving apparatus of claim 14, wherein the guide member includes:
a guide supporting portion that supports a rear surface of the vibration module;
a guide portion that is connected to the guide supporting portion and guides the spring member;
a protruding portion extending from the guide portion, penetrating the base plate, and protruding outside the base plate; and
a fastening portion fastened to the protrusion portion.

16. The vibration driving apparatus of claim 15, wherein the spring member is wound around the guide portion.

17. The vibration driving apparatus of claim 1, wherein the vibration module includes:
a vibration layer including piezoelectric materials;
a first electrode layer on a first surface of the vibration layer; and
a second electrode layer on a second surface different from the first surface of the vibration layer.

18. The vibration driving apparatus of claim 1, further comprising:
a dummy plate between the vibration member and the vibration module.

19. The vibration driving apparatus of claim 18, wherein the dummy plate has a size equal to or larger than a size of the vibration module.

20. The vibration driving apparatus of claim 1, wherein the vibration apparatus includes a first vibration apparatus and a second vibration apparatus disposed parallel to each other on a first surface of the vibration member, and
wherein the first vibration apparatus and the second vibration apparatus are the same vibration apparatus.
